(19) United States
(12) Patent Application Publication
(10) Pub. No.: US 2009/0113963 A1
(43) Pub. Date: May 7, 2009

(54) Electronic lock system and method of use thereof

(76) Inventor: Alan L. Pocrass, Simi Valley, CA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/913,510

(22) PCT Filed: May 1, 2006
(86) PCT No.: PCT/US06/16493

§ 371 Date: May 21, 2008

Related U.S. Application Data
(60) Provisional application No. 60/679,125, filed on May 3, 2005.

(51) Int. Cl. E05B 47/00

(52) U.S. Cl. 70/277

(57) ABSTRACT

In an electronic lock system, a lock includes a lock housing (6) with an integral female USB connector (6), a lock mechanism supported by the lock housing, and a storage supported by the lock housing and operative for storing a first, predetermined electronic image. A key (4) includes a key housing, an imaging system supported by the key hosing and operative for determining a second electronic image of non optical features of a body part in contact with the key, and a male USB connector (1θ) supported by the key housing and interfaced with the imaging system for passage of or permitting access to the second electronic image. A computational unit (32) is provided and is operative for comparing the first and second electronic images when the male and female USB connectors are mated and for causing the lock mechanism to move to its open or closed position as a function of the comparison.

### CROSS REFERENCE TO RELATED APPLICATIONS

This application claims priority from U.S. Provisional Patent Application No. 60/679,125, filed May 3, 2005, which is incorporated herein by reference.

### BACKGROUND OF THE INVENTION

1. Field of the Invention

The present invention relates to an electronic lock system.

2. Description of Related Art

Prior art mechanical lock systems, comprising a mechanical key and a mechanical lock mechanism, are well-known in the art. With prior art mechanical lock systems there is a need to have each mechanical key have the same configuration corresponding to the tumbler configuration of the lock in order to activate, i.e., open or close, the mechanical lock mechanism. One problem with this arrangement is that should there be a need to change the mechanical lock, e.g., for security reasons, it is necessary to change both the mechanical lock mechanism and each mechanical key. For owners or users of such mechanical lock systems, the replacement of a lock and key can be both time consuming and expensive since it typically requires replacement of an installed mechanical lock system with a new mechanical lock system.

Moreover, it is well-known that such mechanical lock systems are not secure in that the mechanical lock mechanism can be picked or a so-called skeleton key can be made that can open a number of different mechanical lock mechanisms having slightly different configurations.

Accordingly, there is a need to improve on the prior art mechanical lock systems wherein the above problems and others are overcome.

### SUMMARY OF THE INVENTION

The invention is an electronic lock system that includes a key having a first housing including an integral male USB connector; an imaging system supported via the first housing and operative for generating data about a body part in contact with the key, wherein the generated data is data other than data regarding optical surface features of the body part; and a first computational unit supported via the first housing and operative for determining a first image of the body part from the generated data and for making said first image available to the male USB connector.

The imaging system includes a detector which generates the data in response to detecting one of the following: a pattern of light scattered from within the body part; a pattern of heat emanating from the body part; and an impedance pattern of the body part. When a pattern of scattered light is detected, the first image is an image of blood vessels in the body part. When a pattern of heat is detected, the first image is a thermal image of the body part. When an impedance pattern is detected, the first image is an image of the impedance of the body part.

The lock system can further include a lock having a lock mechanism supported by a second housing; an integral female USB connector configured to mate with the male USB connector; and a second computational unit operative for communicating with the first computational unit when the male and female USB connectors are mated, wherein at least one computational unit is operative for causing the lock mechanism to be in its open or closed position as a function of the first image.

The one computational unit can also be operative for comparing the first image to a second, predetermined image and for causing the lock mechanism to open or close as a function of said comparison.

The key and the lock can each include a code stored therein. At least one computational unit can be operative for comparing the code stored in the key to the code stored in the lock and for causing the lock mechanism to open or close as a function of the comparison of said codes.

Alternatively, the lock can include a lock mechanism supported by a second housing; an integral female USB connector configured to mate with the male USB connector; and a storage for storing a second, predetermined image, wherein the first computational unit can be operative for comparing the first image to the second image when the male and female USB connectors are mated and for causing the lock mechanism to open or close as a function of said comparison.

A battery can be provided for supplying electrical power to at least one of the following: the imaging system; the first computational unit; and the second computational unit.

The invention is also an electronic lock system comprising a lock and a key. The lock includes a lock mechanism supported by a first housing; a female USB connector supported by the first housing; and a computational unit supported by the first housing and interfaced with the lock mechanism and the female USB connector. The computational unit is operative for analyzing via the female USB connector an image of a body part in contact with the key and for causing the lock mechanism to be in its open or closed position as a function of the analysis, wherein the image is other than an image of optical surface features of the body part.

The key includes a male USB connector supported by a second housing and configured to mate with the female USB connector; and an imaging system supported by the second housing and operative for acquiring data from which the computational unit can determine the image of the body part in contact with the key, wherein the computational unit is operative for analyzing the image of the body part when the male and female USB connectors are mated. The analysis of the image of the body part can include comparing the image to a reference image that can be stored at the lock.

The invention is also a method of causing a lock mechanism to open or close. The method comprises (a) providing a key having: a housing supporting an integral male USB connector, and means for determining a first electronic image of a body part in contact with the key, wherein the first image is an image of nonoptical features of the body part; (b) determining the first electronic image of the body part in contact with the key; (c) providing a lock having: a housing supporting an integral female USB connector configured to mate with the male USB connector; means for storing a second electronic image of the body part; and a lock mechanism; (d) causing the first and second images to be compared when the male and female USB connectors are mated; and (e) causing the lock mechanism to move to its open or closed position as a function of the comparison.

Each electronic image can be one of the following: an image of blood vessels in the body part; a thermal image of the body part; and an image of the impedance of the body part.

The means for storing the second electronic image can be part of a computational unit that is interfaced with the female USB connector. The computational unit can be operative for causing the lock mechanism to move to its open or closed position.

Prior to step (d), the method can further include storing the second electronic image in the means for storing.

Step (d) can further include causing a code stored in the lock to be compared to a code stored in the key. Step (e) can further include causing the lock mechanism to move to its open or closed position as a function of the comparison of the codes.

Lastly, the invention is an electronic lock system comprising: a lock having a lock housing with an integral female USB connector; a lock mechanism supported by the lock housing; and an electronic storage supported by the lock housing and operative for storing a first, predetermined electronic image. The electronic lock system can also include a key having: a key housing; an imaging system supported by the key housing and operative for determining a second electronic image of a body part in contact with the key and for at least temporarily storing the second electronic image, wherein the second electronic image is an image of nonoptical features of the body part; and a male USB connector supported by the key housing and interfaced with the imaging system for passage of or permitting access to the second electronic image.

The electronic lock system can also include a computational unit operative for comparing the first and second electronic images when the male and female USB connectors are mated and for causing the lock mechanism to move to its open or closed position as a function of said comparison.

The key and the lock can each also store an electronic code that the computational unit compares and causes the lock mechanism to be in its open or closed state as a function of the comparison.

The electronic lock system can also include an electrical power source operative for providing electrical power to at least one of the following: the storage; the imaging system; and the computational unit.

The second electronic image can be one of the following: an image of blood vessels in the body part; a thermal image of the body part; and an image of the impedance of the body part.

### BRIEF DESCRIPTION OF THE DRAWINGS

FIG. 1 is a schematic view of an electronic lock system having an electronic key and an electronic lock in accordance with the present invention;

FIG. 2 is a block diagram of the internal components of one exemplary embodiment of the key of FIG. 1;

FIG. 3 is a block diagram of the internal components of one exemplary embodiment of the lock of FIG. 1; and

FIG. 4 is a perspective view of an electronic lock system in accordance with the present invention having a different physical configuration than the schematic view of the electronic lock system shown in FIG. 1.

### DETAILED DESCRIPTION OF THE INVENTION

The present invention will be described with reference to the accompanying figures where like reference numbers correspond to like elements.

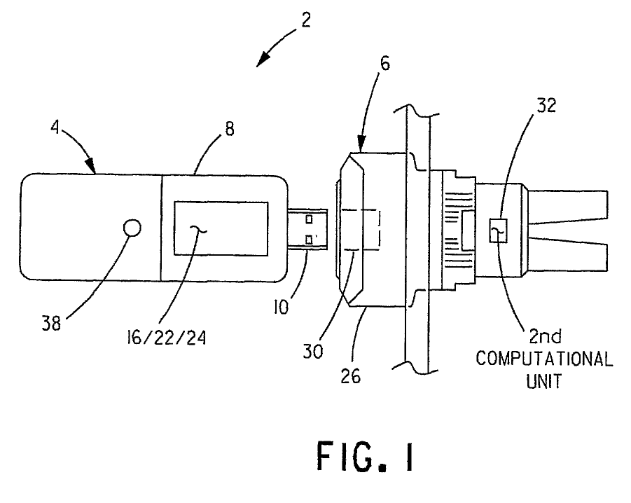

With reference to FIG. 1, an electronic lock system 2 in accordance with the present invention includes a key 4 and a lock 6.

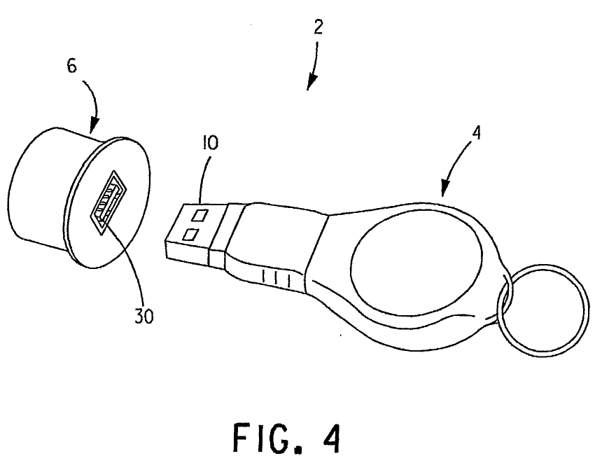

Key 4 includes a housing 8 having an integral male USB connector 10 extending therefrom. In one embodiment, housing 8 and male USB connector 10 have the form of a conventional USB flash drive. However, this is not to be construed as limiting the invention since it is envisioned that housing 8 and male USB connector 10 can have any suitable and/or desirable form (see, e.g., FIG. 4).

With reference to FIG. 2 and with continuing reference to FIG. 1, key 4 includes an imaging system 12 that is supported by housing 8. Three exemplary embodiments of imaging system 12 suitable for use in the present invention will now be described.

It is well-known that imaging systems that detect optical surface features of body parts, such as fingertips, can easily be deceived and, therefore, represent a security risk. To avoid such security risk, in accordance with the present invention, the various embodiments of imaging system 12 described hereinafter generate data other than data regarding optical surface features of the body part.

A first embodiment imaging system 12 is operative for providing light to a body part, such as a fingertip 18, and for receiving light scattered from within the body part, i.e., from below the surface of the body part. Imaging system 12 includes an illumination subsystem 14 configured to direct light at one or more suitable wavelengths, desirably between 400 nanometers and 2.5 micrometers, to a pad or platen 16 configured to receive the body part of a user of key 4, such as a fingertip 18, for illumination by the light from illumination subsystem 14. Hereinafter, it will be assumed for the purpose of discussion that the body part being imaged is fingertip 18, e.g., without limitation, the fingerprint, of a user of key 4. However, this is not to be construed as limiting the invention since it is envisioned that the body part being imaged can be a thumbprint, a palm print, or any other suitable and/or desirable body part.

Light scattered within fingertip 18 is detected by a detection subsystem 20 of imaging system 12. An example of such a first embodiment imaging system includes the LightPrint™ multispectral imager commercially available from Lumidigm, Inc., 800 Bradbury Southeast, Suite 213, Albuquerque, N. Mex. 87106, details of which are disclosed in United States Patent Application Publication No. US 2004/0240712 to Rowe et al., which is incorporated herein by reference.

A second embodiment imaging sensor 12 includes a thermal sensor 22 (shown in phantom) which can replace the illumination subsystem 14, platen 16 and detection subsystem 20 of the first embodiment imaging system 12. Thermal sensor 22 can be sized to detect the thermal image of a large area of fingertip 18 or can be a so-called swipe sensor that acquires a thermal image of fingertip 18 in response to swiping fingertip 18 across thermal sensor 22 in the form of the so-called swipe sensor. One exemplary swipe sensor is commercially available from Amtel Corporation of San Jose, Calif. under the trademark FingerChip™.

Lastly, a third embodiment imaging sensor 12 includes an electric field sensor 24 (shown in phantom) which can replace thermal sensor 22. One non-limiting example of a suitable electric field sensor for use in the present invention is disclosed in U.S. Pat. No. 6,069,970 to Salatino et al., which is incorporated herein by reference. Electric field sensors 24, of the type disclosed in the Salatino et al. patent, utilize electric fields to detect an impedance pattern of fingertip 18 and output data regarding this detection for suitable processing.

Regardless of the type of imaging system 12 selected, i.e., light based, thermal based or electric field based, the output of said imaging system 12 is supplied to a first computational unit 25 of key 4 which processes said data to construct a first image of fingertip 18. Where imaging system 12 utilizes light scattered within fingertip 18, the first image is a pattern of blood vessels in fingertip 18. Where the imaging system is thermal sensor 22, the first image is a thermal image of fingertip 18. Lastly, where imaging system 12 is electric field sensor 24, the first image is a set of impedance values of fingertip 18 acquired by electric field sensor 24. As would be appreciated by one skilled in the art, the first image resides in first computational unit 25 in electronic form. However, this is not to be construed as limiting the invention.

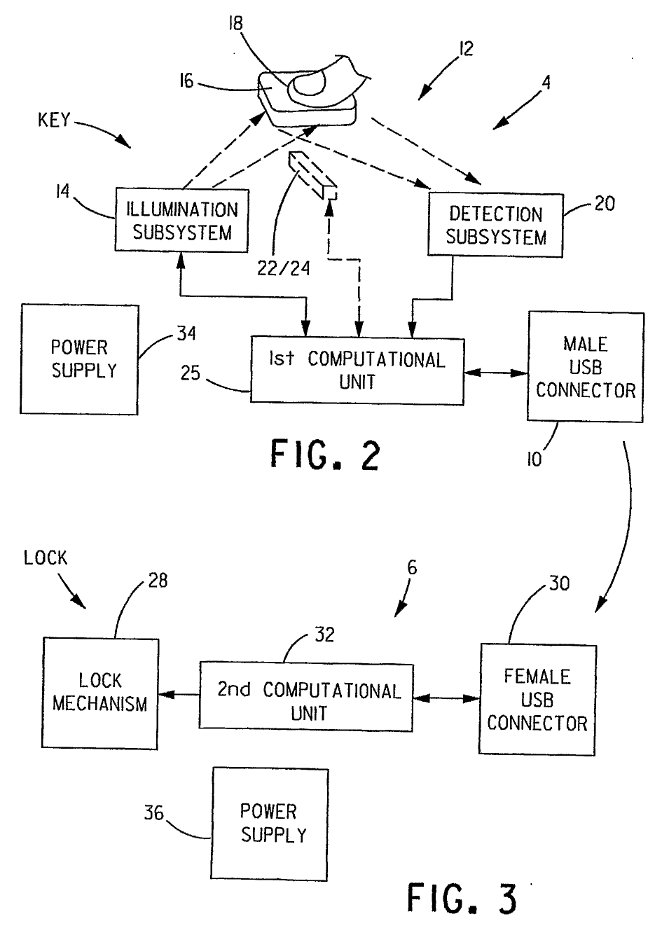

With reference to FIG. 3 and with continuing reference to FIGS. 1 and 2, lock 6 includes a housing 26 supporting a lock mechanism 28 and an integral female USB connector 30 which is interfaced with a second computational unit 32 which is operative for causing lock mechanism 28 to be in its open or closed state for reasons to be discussed hereinafter.

Desirably, male and female USB connectors 10 and 30 are type A USB connectors. However, this is not to be construed as limiting the invention since it is envisioned that male and female USB connectors 10 and 30 can be type B USB connectors, mini-type A USB connectors, or mini-type B USB connectors.

First computational unit 25 and second computational unit 32 can each comprise any suitable form or arrangement of components necessary and/or desirable to perform the functions described herein. In one exemplary, non-limiting embodiment, computational unit 25 or 32 includes, without limitation, a microprocessor and suitable storage memory, such as, without limitation, flash memory, for storage of instructions or program code that cause the processor to perform the functions described herein. The computational unit may also include any additional suitable and/or desirable support circuitry interfaced with the microprocessor which, in turn, is interfaced with the USB connector. Accordingly, each computational unit is to be understood as comprising the necessary hardware and, as necessary, program code to perform the functions described herein and is not to be construed as limiting the invention.

Prior to using electronic lock 2, it is necessary that second computational unit 32 of lock 6 be programmed with at least one electronic image corresponding to an electronic image to be determined by key 4 by way of imaging system 12. For example, an image corresponding to an image to be determined by imaging system 12 of key 4 can be programmed into (stored in) second computational unit 32 by way of female USB connector 30 connected to a programming device. (To avoid the unauthorized storage of electronic images in second computational unit 32, second computational unit 32 can also be programmed with a permanent or modifiable access code that the programming device must supply to second computational unit 32 as a condition precedent to the storage of one or more electronic images therein. For example, the programming device may be programmed to download the access code of lock 6 into second computational unit 32 via female USB connector 30. Upon comparing and determining that the downloaded access code matches the access code programmed into second computational unit 32, second computational unit 32 permits the programming device to store one or more images in second computational unit 32. This same access code may also be utilized as a secondary means for determining that a particular key 4 is authorized to work with lock 6 in the manner to be described hereinafter.

The programming device utilized to program second computational unit 32 of lock 6 with one or more electronic images can be a laptop or desktop computer (not shown) connected to second computational unit 32 by way of female USB connector 30 of lock 6 via suitable cabling. Also or alternatively, key 4 can be utilized as the programming device to program one or more electronic images into second computational unit 32 by way of female USB connector 30 of lock 6 and male USB connector 10 of key 4.

Where key 4 is utilized as the programming device, male USB connector 10 of key 4 is initially inserted into the female USB connector of a laptop or desktop computer which is controlled to download into first computational unit 25 of key 4 the one or more electronic images desired to be stored in second computational unit 32 of lock 6. Once these one or more images have been downloaded into first computational unit 25 of key 4, male USB connector 10 of key 4 is separated from said computer and is mated with female USB connector 30 of lock 6. Thereafter, in response to activation of a download button 38 of key 4, any electronic images stored in first computational unit 25 can be downloaded into second computational unit 32 for storage. Desirably, once each electronic image has been stored in second computational unit 32, said electronic image can be deleted from first computational unit 25. However, this is not to be construed as limiting the invention.

At a suitable time after one or more electronic images have been stored in second computational unit 32 and when it is desired to cause lock mechanism 28 to move to its open or closed state, male USB connector 10 and female USB connector 30 are mated. Thereafter, an electronic image of fingertip 18 determined by first computational unit 25, in response to the generation of data by detection subsystem 20, thermal sensor 22 or electric field sensor 24 of key 4 by the stationary or moving contact of fingertip 18 in contact with pad 16, thermal sensor 22 or electric field sensor 24, respectively, of key 4 is compared to one or more correspondingly formatted electronic images stored in second computational unit 32. As a function of this comparison, especially a match between one or more characteristics of the electronic image determined by key 4 and one or more characteristics of one of the electronic images stored in second computational unit 32, lock mechanism 28 is caused to move to its open position from its closed position, or vice versa. The comparison of the one or more characteristic(s) of the electronic image of fingertip 18 determined by first computational unit 25 to one or more characteristic(s) of one of the electronic images stored in second computational unit 32 can be made at first computational unit 25, second computational unit 32, some combination of first computational unit 25 and second computational unit 32, or both. Accordingly, the location where this comparison is made is not to be construed as limiting the invention.

If desired, key 4 can also be programmed with the same access code as is programmed into second computational unit 32. In this case, like the programming device discussed above, a match between the access code programmed into first computational unit 25 and the access code programmed into second computational unit 32 may be a condition precedent to causing lock mechanism 28 to move to its open or closed position, in addition to the match between one or more characteristics of the electronic image determined at key 4 and one or more characteristics of one of the electronic images stored at lock 6 by the programming device. When two or more electronic images are stored at lock 6, each electronic image can be the fingertip of a different person, e.g., different members of the same family and/or a guest authorized to enter a family home where lock 6 is installed.

The first computational unit 25 can be programmed to cause imaging system 12 to generate data regarding fingertip 18 in stationary or moving contact with pad 16, thermal sensor 22 or electric field sensor 24 of key 4 at any suitable and/or desirable time before or during the time male and female USB connectors 10 and 30 are mated. Thereafter, the programming code of first computational unit 25 cause it to construct or determine the electronic image of fingertip 18 corresponding to the generated data.

Desirably, the electronic image determined by first computational unit 25 is only stored briefly for security reasons. For example, first computational unit 25 can be programmed to only determine the electronic image of fingertip 18 when male and female USB connectors 10 and 30 are mated. In another example, the electronic image of fingertip 18 can be determined by first computational unit 25 a few moments before male and female USB connectors 10 and 30 are mated whereupon the comparison of the electronic image determined by first computational unit 25 to one or more images stored in second computational unit 32 can occur after mating male and female USB connectors 10 and 30. In any event, it is desirable that the electronic image determined by first computational unit 25 be only stored temporarily, with said electronic image being deleted after a predetermined interval of time or after attempting to cause lock 6 to move to its open or closed state, e.g., upon or after separation of male and female USB connectors 10 and 30.

The electrical power for the components of key 4 that utilize electrical power for their operation can come from a power supply 34 of key 4. Power supply 34 can be any form of suitable and/or desirable electrical power supply, such as, without limitation, a battery, a solar cell, etc. Lock 6 can also include a power supply 36, like power supply 34, for powering any electric power consumption devices of lock 6, e.g., second computational unit 32. The foregoing description of key 4 and lock 6 having separate power supplies 34 and 36, respectively, however, is not to be construed as limiting the invention since it is envisioned that only one of key 4 and lock 6 can have a power supply which is utilized to not only supply electrical power to the components thereof, but to also supply electrical power to the components of the other of key 4 and lock 6 when male and female USB connectors 10 and 30 are mated.

For example, it may be desirable that only lock 6 includes power supply 36 and that key 4 derives its electrical power from power supply 36 when male and female USB connectors 10 and 30 are mated to avoid retention of an electronic image determined by first computational unit 25 of key 4 after separation of male and female USB connectors 10 and 30. Alternatively, it may be desirable that only key 4 include power supply 34 and that lock 6 derive its electrical power from power supply 34 when male and female USB connectors 10 and 30 are mated to avoid having to replace power supply 36 in lock 6 after it has been installed and such power supply may not be readily accessible.

While key 4 and lock 6 have been described as having first and second computational units 25 and 32, respectively, it is envisioned that one of said computational units 25 and 32 can be omitted and the functions of key 4 and lock 6 described above can be performed by the remaining computational unit when male and female USB connectors 10 and 30 are mated.

For example, the microprocessor of second computational unit 32 can be omitted whereupon the memory storage of second computational unit 32 is utilized to store predetermined electronic images and any support circuitry of second computational unit 32 is operated under the control of first computational unit 25 when male and female USB connectors 10 and 30 are mated. In this embodiment, first computational unit 25 determines an electronic image from data acquired by imaging system 12 and compares this determined electronic image to one or more images stored in the memory storage of lock 6. As a function of this comparison, especially a match between the electronic image determined by key 4 and one of the electronic images stored at lock 6, first computational unit 25 can cause lock mechanism 28 to move to its open or closed state by way of the support circuitry of second computational unit 32 which, in this embodiment, does not include a microprocessor.

Alternatively, the microprocessor of first computational unit 25 can be omitted whereupon imaging system 12 of first computational unit 25 can be operated under the control of second computational unit 32, which in this example, includes a microprocessor, to generate data from which second computational unit 32 can determine a corresponding electronic image when male and female USB connectors 10 and 30 are mated. Thereafter, second computational unit 32 can compare this determined electronic image to one or more predetermined electronic images stored at second computational unit 32 and can cause lock mechanism 28 to move to its open or closed position as a function of this comparison, especially a match between the electronic image determined from data generated by imaging system 12 and one of the electronic images stored at second computational unit 32.

As can be seen, the present invention is an electronic lock system that includes a key 4 having a male USB connector 10, and a lock 6 having a female USB connector 30. A computational unit is provided in one or both of the lock and key to facilitate generating data about a body part in contact with the key, for constructing or determining an image of the body part from the acquired data, for comparing the determined image to a stored or predetermined image, and causing the lock mechanism to open or close as a function of the comparison, especially a match between the determined image and the predetermined image.

The invention has been described with reference to the preferred embodiments. Obvious modifications and alterations will occur to others upon reading and understanding the preceding detailed description. For example, the physical configuration of key 4 and lock 6 in FIG. 1 is not to be construed as limiting the invention since it is envisioned that key 4 and/or lock 6 can have any suitable and/or desirable configuration, including, without limitation, the physical configuration shown in FIG. 4. It is intended that the invention be construed as including all such modifications and alterations insofar as they come within the scope of the appended claims or the equivalents thereof.

The invention claimed is:

1. An electronic lock system comprising:
a key having:
a first housing including an integral male USB connector;
an imaging system supported via the first housing and operative for generating data about a body part in contact with the key, wherein the generated data is data other than data regarding optical surface features of the body part; and
a first computational unit supported via the first housing and operative for determining a first image of the body part from the generated data and for making said first image available to the male USB connector.

2. The system of claim 1, wherein the imaging system includes a detector which generates the data in response to detecting one of the following:
a pattern of light scattered from within the body part;
a pattern of heat emanating from the body part; and
an impedance pattern of the body part.

3. The system of claim 2, wherein:
when a pattern of scattered light is detected, the first image is an image of blood vessels in the body part;
when a pattern of heat is detected, the first image is a thermal image of the body part; and
when an impedance pattern is detected, the first image is an image of the impedance of the body part.

4. The system of claim 1, further comprising:
a lock having:
a lock mechanism supported by a second housing;
an integral female USB connector configured to mate with the male USB connector; and
a second computational unit operative for communicating with the first computational unit when the male and female USB connectors are mated, wherein at least one computational unit is operative for causing the lock mechanism to be in its open or closed position as a function of the first image.

5. The system of claim 4, wherein the at least one computational unit is operative for comparing the first image to a second, predetermined image and for causing the lock mechanism to open or close as a function of said comparison.

6. The system of claim 4, wherein:
the key includes a code stored therein;
the lock includes the code stored therein; and
at least one computational unit is operative for comparing the code stored in the key to the code stored in the lock and for causing the lock mechanism to open or close as a function of the comparison of said codes.

7. The system of claim 1, further comprising:
a lock having:
a lock mechanism supported by a second housing;
an integral female USB connector configured to mate with the male USB connector; and
a storage for storing a second, predetermined image, wherein the first computational unit is operative for comparing the first image to the second image when the male and female USB connectors are mated and for causing the lock mechanism to open or close as a function of said comparison.

8. The system of claim 7, wherein:
the key includes a code stored therein;
the lock includes the code stored therein; and
the first computational unit is operative for comparing the code stored in the key to the code stored in the lock and for causing the lock mechanism to open or close as a function of the comparison of said codes.

9. The system of claim 4, further including a battery for supplying electrical power to at least one of the following:
the imaging system;
the first computational unit; and
the second computational unit.

10. An electronic lock system comprising a lock and a key, said lock comprising:
a lock mechanism supported by a first housing;
a female USB connector supported by the first housing; and
a computational unit supported by the first housing and interfaced with the lock mechanism and the female USB connector, the computational unit operative for analyzing via the female USB connector an image of a body part in contact with the key and for causing the lock mechanism to be in its open or closed position as a function of the analysis, wherein the image is other than that of optical surface features of the body part.

11. The system of claim 10, wherein said key comprises:
a male USB connector supported by a second housing and configured to mate with the female USB connector; and
an imaging system supported by the second housing and operative for acquiring data from which the computational unit can determine the image of the body part in contact with the key, wherein the computational unit is operative for analyzing the image of the body part when the male and female USB connectors are mated.

12. The system of claim 11, wherein the analysis of the image of the body part comprises comparing said image to a reference image.

13. The system of claim 11, wherein the reference image is stored at the lock.

14. A method of causing a lock mechanism to open or close, the method comprising:
(a) providing a key having:
a housing supporting an integral male USB connector, and
means for determining a first electronic image of a body part in contact with the key, wherein the first image is an image of nonoptical features of the body part;
(b) determining the first electronic image of the body part in contact with the key;
(c) providing a lock having:
a housing supporting an integral female USB connector configured to mate with the male USB connector;
means for storing a second electronic image of the body part; and
a lock mechanism;
(d) causing the first and second images to be compared when the male and female USB connectors are mated; and
(e) causing the lock mechanism to move to its open or closed position as a function of the comparison.

15. The method of claim 14, wherein each electronic image is one of the following:
an image of blood vessels in the body part;
a thermal image of the body part; and
an image of the impedance of the body part.

16. The method of claim 14, wherein the means for storing the second electronic image is part of a computational unit that is interfaced with the female USB connector.

17. The method of claim 16, wherein the computational unit is operative for causing the lock mechanism to move to its open or closed position.

18. The method of claim 14, further including, prior to step (d), storing the second electronic image in the means for storing.

19. The method of claim 14, wherein:
step (d) further includes causing a code stored in the lock to be compared to a code stored in the key; and
step (e) further includes causing the lock mechanism to move to its open or closed position as a function of the comparison of the codes.

20. An electronic lock system comprising:
a lock having:
a lock housing with an integral female USB connector;
a lock mechanism supported by the lock housing; and
an electronic storage supported by the lock housing and operative for storing a first, predetermined electronic image.

21. The system of claim 20, further including:
a key having:
a key housing;
an imaging system supported by the key housing and operative for determining a second electronic image of a body part in contact with the key and for at least temporarily storing the second electronic image, wherein the second electronic image is an image of nonoptical features of the body part; and
a male USB connector supported by the key housing and interfaced with the imaging system for passage of or permitting access to the second electronic image.

22. The system of claim 21, further including a computational unit operative for comparing the first and second electronic images when the male and female USB connectors are mated and for causing the lock mechanism to move to its open or closed position as a function of said comparison.

23. The system of claim 22, wherein:
said key also stores an electronic code;
said lock also stores the electronic code; and
the computational unit is also operative for comparing the electronic code stored in the key to the electronic code stored in the lock and for causing the lock mechanism to move to its open or closed position as a function of the comparison of the electronic codes.

24. The system of claim 21, further including an electrical power source operative for providing electrical power to at least one of the following:
the storage;
the imaging system; and
the computational unit.

25. The system of claim 24, wherein the second electronic image is one of the following:
an image of blood vessels in the body part;
a thermal image of the body part; and
an image of the impedance of the body part.
